(19) United States
(12) Patent Application Publication
(10) Pub. No.: US 2017/0008456 A1
(43) Pub. Date: Jan. 12, 2017

(54) SYSTEM FOR ELIMINATING BLIND SPOTS OF AN INDUSTRIAL VEHICLE

(71) Applicant: Murray Van Wieringen, Corunna, MI (US)

(72) Inventor: Murray Van Wieringen, Corunna, MI (US)

(21) Appl. No.: 14/858,003

(22) Filed: Sep. 18, 2015

Related U.S. Application Data
(60) Provisional application No. 62/188,833, filed on Jul. 6, 2015.

(51) Int. Cl. B60R 1/00

(52) U.S. Cl. CPC B60R 1/00; B60R 2300/802

(57) ABSTRACT

A system for eliminating blind spots is provided. The system includes a vehicle having a vehicle cabin with a viewing port. The vehicle further includes vehicle machinery obstructing at least a portion of the view from the view port, which forms a blind spot. At least one video camera is secured to the vehicle and directed to take a streaming video of the blind spot. At least one display is secured to the vehicle machinery on a side facing the vehicle cabin. The streaming video is displayed from the display so that an exemplary user sees the blind spot caused by the vehicle machinery.

### CROSS-REFERENCE TO RELATED APPLICATION

This application claims the benefit of priority of U.S. provisional application No. 62/188,833, filed Jul. 6, 2015, the contents of which are herein incorporated by reference.

### BACKGROUND OF THE INVENTION

The present invention relates to industrial vehicles and, more particularly, to a system for eliminating blind spots of an industrial vehicle.

A forklift is a powered industrial truck used to lift and move materials short distances. The mast is the vertical assembly that does the work of raising and lowering the load. It is made up of interlocking rails that also provide lateral stability. The interlocking rails may either have rollers or bushings as guides. The mast is driven hydraulically, and operated by one or more hydraulic cylinders directly or using chains from the cylinder/s. It may be mounted to the front axle or the frame of the forklift. Since the mast is located at the front end of the forklift, the vertical assembly creates blind spots in front of the driver. Injury or death may occur at the workplace because a forklift operator may not see a co-worker due to the blind spots mentioned above.

As can be seen, there is a need for a system that eliminates blind spots of an industrial vehicle.

### SUMMARY OF THE INVENTION

In one aspect of the present invention, a system for eliminating blind spots comprises: a vehicle comprising a vehicle cabin having a viewing port and a vehicle machinery obstructing at least a portion of a view of the viewing port; at least one video camera secured to the vehicle and positioned to capture streaming video beyond the portion of the view that is obstructed; and at least one display secured to the vehicle machinery on a side facing the vehicle cabin, wherein the streaming video is displayed from the at least one display.

These and other features, aspects and advantages of the present invention will become better understood with reference to the following drawings, description and claims.

### BRIEF DESCRIPTION OF THE DRAWINGS

FIG. 1 is a schematic perspective view of an embodiment of the present invention shown in use;

FIG. 2 is a schematic view of an embodiment of the present invention;

FIG. 3 is a schematic view of an embodiment of the present invention; and

FIG. 4 is a schematic view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a vision safety system for eliminating blind spots of lift equipment. Typically a forklift includes a mast that blocks the vision of the operator. A plurality of sensors may be attached to the forklift and sense objects that are in front of the mast. The display is attached to the mast on the side in which the operator is facing. A processing unit receives the data from the sensors and the operator position detector and produces an image on the display so that it appears the operator is seeing through the mast, and thereby removing the blind spots.

In certain embodiments, the sensor(s) survey the area in front of forklift; image data is sent to the processing unit; the operator perspective is determined and sent to the processing unit; an algorithm is used to calculate a proper image and the image is displayed on the display for the operator to view in front of the forklift.

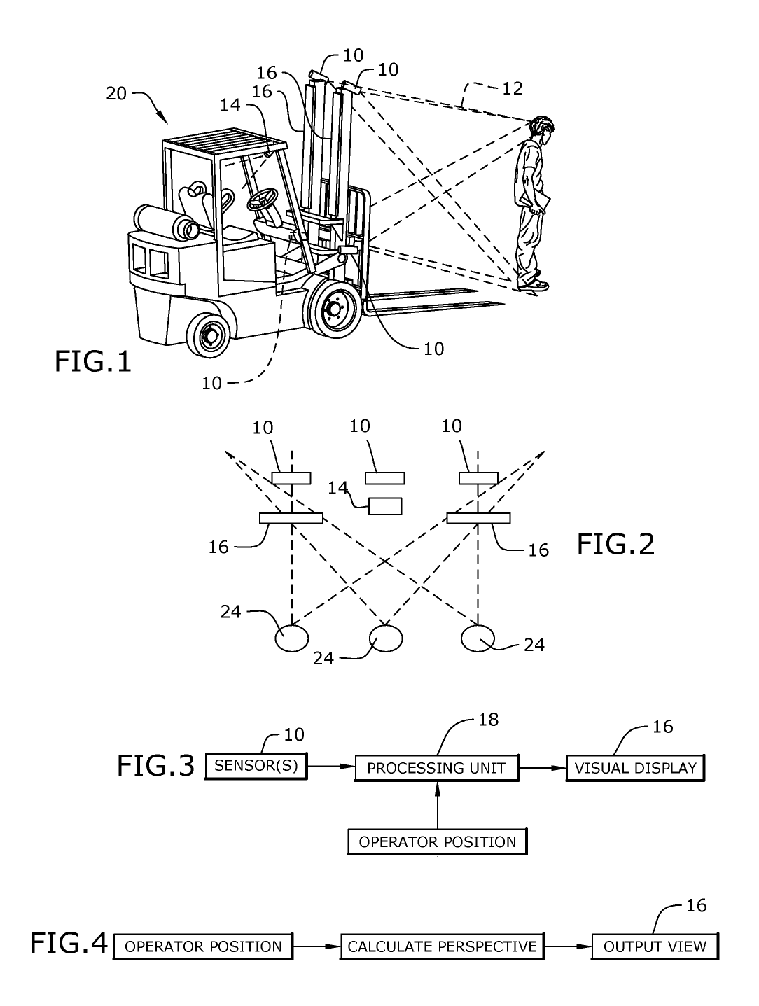

Referring to FIGS. 1 through 4, the present invention includes a system for eliminating blind spots. The system includes a vehicle 20 having a vehicle cabin with a viewing port. The vehicle 20 further includes vehicle machinery obstructing at least a portion of the view from the view port, which forms a blind spot. At least one video camera 10 is secured to the vehicle and directed to take a streaming video beyond the portion of the view that is obstructed. At least one display 16 is secured to the vehicle machinery on a side facing the vehicle cabin. The streaming video is displayed from the display 16 so that an exemplary user sees the blind spot caused by the vehicle machinery.

In certain embodiments the present invention may further include a sensor 14 pointed towards a seat within the vehicle cabin. The sensor 14 detects a position of the user within the vehicle cabin. The present invention may further include a processor unit operatively connected to the sensor 14, the video camera 10 and the display 16. The processor receives data from the sensor 14 and processes a position of the blind spot relative to the position of the user within the vehicle cabin using an algorithm. The video cameras 10 are adjusted to record video beyond the determined blind spot and the recorded video is then displayed on the display. The above process may be performed constantly. Therefore, when the user moves positions within the vehicle cabin causing a new blind spot, the video cameras 14 are adjusted to show the user beyond the blind spot of the new position.

In certain embodiments, the vehicle 20 is a forklift. The vehicle machinery of the forklift may include the mast having a first upright and a second upright (vertical assembly). In such embodiments, a first display 16 may be attached to the first upright and a second display may be attached to the second upright. The display may cover at least a substantially portion of the first upright and the second upright that is obstructing the portion of the view. In certain embodiments, the displays 16 only display streaming video of the view that is obstructed. Therefore, the user perceives seeing through the first and second uprights.

The present invention may include a plurality of video cameras 10 providing different views to be displayed. For example, a video camera 10 may be secured near the bottom and top of the first upright and the second upright. The plurality of video cameras 10 provides a wider range of views when the user is positioned at different angles within the vehicle cabin.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for eliminating blind spots comprising:
a vehicle comprising a vehicle cabin having a viewing port and a vehicle machinery obstructing at least a portion of a view of the viewing port;
at least one video camera secured to the vehicle and positioned to capture streaming video beyond the portion of the view that is obstructed; and
at least one display secured to the vehicle machinery on a side facing the vehicle cabin, wherein the streaming video is displayed from the at least one display.

2. The system of claim 1, further comprising a sensor to detect a location of a user within the vehicle cabin, and a processing unit operatively connected to the sensor, the at least one video camera, and the display, wherein the processor:
receives data from the sensor;
determines the portion of the view that is obstructed based on the location of the user;
adjusts the video camera to capture streaming video beyond the determined obstructed portion of the view; and
displays the streaming video on the display.

3. The system of claim 2, wherein the display displays only the portion of the view that is obstructed.

4. The system of claim 3, wherein the display covers at least a substantial portion of the vehicle machinery obstructing the portion of the view.

5. The system of claim 1, wherein the vehicle is a fork lift.

6. The system of claim 5 wherein the vehicle machinery is a mast of the forklift, wherein the mast comprises a first upright and a second upright.

7. The system of claim 6, wherein the at least one display is a first display secured to the first upright and a second display secured to the second upright.

8. The system of claim 6, wherein the at least one video camera comprises a first video camera secured the first upright and a second video camera secured to the second upright.
